(19) United States
(12) Patent Application Publication
(10) Pub. No.: US 2015/0118956 A1
(43) Pub. Date: Apr. 30, 2015

(54) Collaborative Coexistence of Near-Field Wireless Systems in a Communication Device

(71) Applicant: Broadcom Corporation, Irvine, CA (US)

(72) Inventors: Prasanna Desai, Elfin Forest, CA (US); John Walley, Ladera Ranch, CA (US); Henrik Tholstrup Jensen, Long Beach, CA (US); Steven Deane Hall, Olivenhain, CA (US); Domitille Esnard-Domerego, Biot (FR); Hea Joung Kim, Irvine, CA (US); Yasantha Rajakarunanayake, San Ramon, CA (US); Ming Lin, Tustin, CA (US); Vadim Bishtein, Sunnyvale, CA (US); Nhan Quang Tran, Fountain Valley, CA (US); Ntsanderh Azenui, Irvine, CA (US)

(73) Assignee: Broadcom Corporation, Irvine, CA (US)

(21) Appl. No.: 14/062,389

(22) Filed: Oct. 24, 2013

(51) Int. Cl. H04B 5/00

(52) U.S. Cl. CPC H04B 5/0037; H04B 5/0075
USPC 455/41.1

(57) ABSTRACT

A communication device includes a first and second near-field wireless (NFW) module operating with a first and second protocol, respectively. A module and method to improve the operational efficiency of the first and second NFW modules are disclosed. Due to close proximity between the first and second NFW modules in the communication device, an undesirable parasitic inductive coupling can occur that can degrade the operational performance of the modules. The first NFW module can be configured to control inductive coupling of the second NFW module when an electromagnetic (EM) field operating with the first protocol is detected. Additionally, the second NFW module can be configured to control inductive coupling of the first NFW module when an EM field operating with the second protocol is detected. Controlling the inductive coupling of each module can be performed by means of detuning an inductive coupling element of each module.

### BACKGROUND OF THE DISCLOSURE

1. Field of the Disclosure

The present disclosure relates generally to a communication device, and more specifically to a collaborative coexistence of near-field wireless (NFW) systems within the communication device.

2. Background Art

Communication devices such as cellular phones have evolved from large devices that were only capable of analog voice communications to comparatively smaller devices that are capable of digital voice communications and digital data communications, such as Short Message Service (SMS) for text messaging, email, packet switching for access to the Internet, gaming, Bluetooth, and Multimedia Messaging Service (MMS) to provide some examples. Even in light of these capabilities, manufacturers of cellular phones are placing even more capabilities into cellular phones and making these more powerful cellular phones smaller and multi-functional. For example, along with near-field communication (NFC) capabilities, the manufacturers are placing wireless power transfer (WPT) capabilities in cellular phones to allow these WPT enabled cellular phones to wireless charge their internal batteries from a wireless power source without the use of a wired connection.

### BRIEF DESCRIPTION OF THE DRAWINGS/FIGURES

The accompanying drawings illustrate the present disclosure and, together with the description, further serve to explain the principles of the disclosure and to enable one skilled in the pertinent art to make and use the disclosure.

FIG. 1 illustrates a block diagram of an exemplary communication device;

FIG. 2A illustrates an exemplary WPT module that can be implemented as part of the exemplary communication device;

FIG. 2B illustrates an exemplary NFC module that can be implemented as part of the exemplary communication device;

FIG. 3A illustrates an exemplary WPT front-end module that can be implemented as part of the exemplary WPT module;

FIG. 3B illustrates an exemplary NFC front-end module that can be implemented as part of the exemplary NFC module;

FIG. 4A illustrates an exemplary WPT controller that can be implemented as part of the exemplary WPT module;

FIG. 4B illustrates an exemplary NFC controller that can be implemented as part of the exemplary NFC module; and

FIG. 5 illustrates a flowchart of exemplary operational steps of a module of the exemplary communication device.

The present disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE DISCLOSURE

The following Detailed Description refers to accompanying drawings to illustrate one or more embodiments consistent with the present disclosure. The disclosed embodiment(s) merely exemplify the disclosure. The embodiment(s) described, and references in the specification to “one embodiment,” “an embodiment,” “an example embodiment,” “an example of this embodiment,” etc., indicate that the embodiment(s) described may include a particular feature, device, or characteristic, but every embodiment may not necessarily include the particular feature, device, or characteristic. Moreover, such phrases are not necessarily referring to the same embodiment. Further, when a particular feature, device, or characteristic is described in connection with an embodiment, it is within the knowledge of those skilled in the relevant art(s) to effect such feature, device, or characteristic in connection with other embodiments whether or not explicitly described.

The embodiments described herein are provided for illustrative purposes, and are not limiting. Other embodiments are possible, and modifications can be made to the embodiments within the spirit and scope of the present disclosure. Therefore, the Detailed Description is not meant to limit the present disclosure. Rather, the scope of the present disclosure is defined only in accordance with the following claims and their equivalents.

Embodiments of the disclosure can be implemented in hardware, firmware, software, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

The following Detailed Description of the embodiments will so fully reveal the general nature of the present disclosure that others can, by applying knowledge of those skilled in relevant art(s), readily modify and/or adapt for various applications such embodiments, without undue experimentation, without departing from the spirit and scope of the disclosure. Therefore, such adaptations and modifications are intended to be within the meaning and plurality of equivalents of the embodiments based upon the teaching and guidance presented herein.

It is to be understood that the phraseology or terminology herein is for the purpose of description and not of limitation, such that the terminology or phraseology of the present specification is to be interpreted by those skilled in relevant art(s) in light of the teachings herein.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

By way of example, components as illustrated in the drawings referenced throughout the disclosure can be configured as a system on a chip (SoC), an integrated circuit (IC), or a plurality of SoC's and/or IC's. It should be noted that any, some, or all of the functionality of the components as illustrated in the drawings referenced throughout the disclosure can be combined as part of a single device or separated amongst multiple devices.

### AN EXEMPLARY COMMUNICATION DEVICE

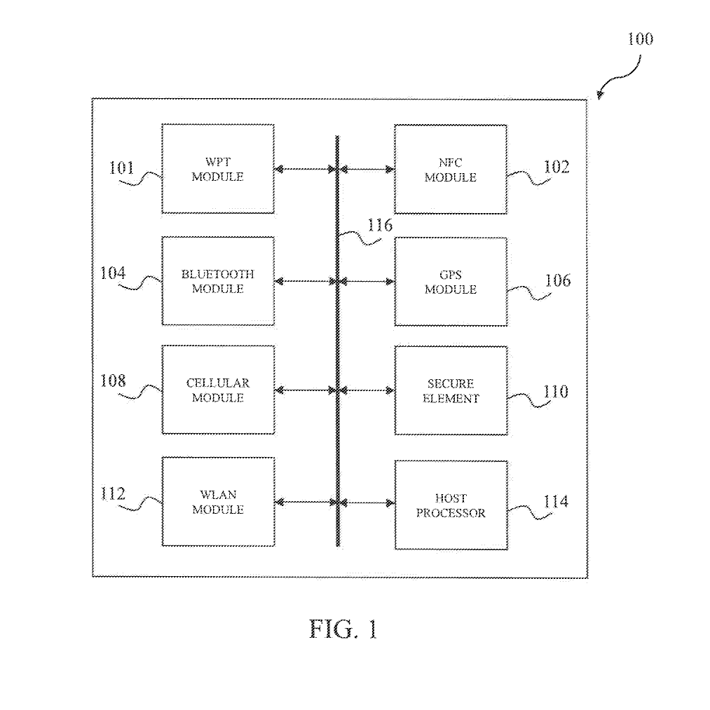

FIG. 1 illustrates a block diagram of a communication device 100 according to a first embodiment of the present disclosure. Communication device 100 can communicate information over wired and/or wireless communication networks in accordance with various communication protocols. Communication device 100 can represent a mobile communication device, such as a cellular phone or a smartphone, a mobile computing device, such as a tablet computer or a laptop computer, or any other electronic device that is capable of communicating information over communication networks that will be apparent to those skilled in the relevant art(s) without departing from the spirit and scope of the present disclosure. This other electronic device can include non-mobile or fixed communication device such as a payment system, such as a point of sale terminal, a ticketing writing system such as a parking ticketing system, a bus ticketing system, a train ticketing system, an entrance ticketing system, a ticket reading system, a toy, a game, a poster, packaging, advertising material, a product inventory checking system and/or any other suitable electronic device that will be apparent to those skilled in the relevant art(s) without departing from the spirit and scope of the disclosure. Communication device 100 a wireless power transfer (WPT) module 101 operating in accordance with a first protocol and a near-field communication (NFC) module 102 operating in accordance with a second protocol. Herein, the WPT module 101 and/or the NFC module 102 can be referred to as near-field wireless (NFW) modules for simplicity. Although, the description of the NFW modules in the present disclosure is to be described in terms of WPT and NFC, those skilled in the relevant art(s) will recognize that the present disclosure may be applicable to other communications that use the near field and/or the far field without departing from the spirit and scope of the present disclosure. It should be noted that communication device 100 is shown in. FIG. 1 to include only two NFW modules 101 and 102 for sake of simplicity. However, communication device 100 can include any number of NFW modules as will be apparent to those skilled in the relevant art(s) without departing from the spirit and scope of the present disclosure.

WPT module 101 can support wireless transmission of power, referred to as WPT, from a wireless power transmitter (not shown) or another similar electronic device that emits a magnetic field. In an embodiment, wireless transmission of power from the wireless power transmitter to WPT module 101 can be done via inductive coupling. Inductive coupling can transfer energy from an inductive structure (e.g. an inductive antenna) of the wireless power transmitter to an inductive structure of WPT module 101 through an electromagnetic (EM) field generated by the wireless power transmitter. In another embodiment, wireless transmission of power from the wireless power transmitter to WPT module 101 can be done via resonant inductive coupling. Such wireless power transmission can be achieved by transferring energy between resonant structures (e.g. resonant antenna) of the wireless power transmitter and WPT module 101. These resonant structures can be tuned to resonate at a specific frequency, or a range of frequencies, referred to as its resonant frequency in an electromagnetic field generated by the wireless power transmitter. The wireless power transmitter and WPT module 101 can be placed in close proximity to achieve inductive coupling or resonant inductive coupling. WPT module 102 can derive or harvest a charging current and/or a charging voltage from the transferred power and deliver the charging current and/or the charging voltage to a load, such as a battery, to provide an example. Typically, this power derived or harvested from the received WPT signal is adequate to operate at least WPT module 101 and/or a Bluetooth module 104.

NFC module 102 can provide wireless communication between communication device 100 and another NFC capable device in accordance with various NFC protocols. Wireless communication between NFC module 102 and another NFC capable device can be achieved via, for example, inductive coupling or resonant inductively coupling. In an embodiment, inductively coupling can transfer modulated information on a carrier frequency from an inductive structure of NFC module 102 to an inductive structure of the other NFC capable device when NFC module 102 operates in an initiator, or a reader, mode of operation and the NFC capable device 102 operates in a target, or a tag, mode of operation. In another embodiment, resonant inductive coupling can transfer information wirelessly between NFC module 102 and the other NFC capable device when their resonant structures are tuned to resonate at the carrier frequency of the modulated information being transferred. In a further embodiment, inductively coupling can transfer modulated information on a carrier frequency from the inductive structure of the other NFC capable device to the inductive structure of NFC module 102 when NFC module 102 operates in tag mode of operation and the NFC capable device 102 operates in the reader mode of operator. It should be that NFC module 102 may be configured to operate in the tag mode and the other NFC capable device may be configured to operate in the reader mode in accordance with the teachings herein as will be apparent to those skilled in the relevant art(s) without departing from the spirit and scope of the present disclosure. Additionally, NEC module 102 can derive or harvest power from communications received from the other NFC capable device when operating in the tag mode of operation. Typically, the power derived or harvested from the received communications is adequate to operate NFC module 102 and/or secure element 110.

WPT module 101 can be further configured to control coupling of NFC module 102 with an electromagnetic (EM) field associated with WPT (“WPT-EM field”). For example, WPT module 101 can be configured to detune the resonant structure of NFC module 102 when WPT module 101 detects an EM field associated with WPT. Detuning of the resonant structure of NFC module 102 can shift the resonant frequency or the range of resonant frequencies of NFC module 102 to a frequency or a range of frequencies that is outside the frequency band of the WPT-EM field, thereby substantially reducing the frequency response of the resonant structure of NFC module 102 to the WPT-EM field. Similarly, NFC module 102 can be configured to control coupling of WPT module 101 with an EM field associated with NFC (“NFC-EM field”) by, for example, detuning the resonant structure of WPT module 101 when NFC module 102 detects the NFC-EM field. Detuning of the resonant structure of WPT module 101 can shift the resonant frequency or the range of resonant frequencies of WPT module 101 to a frequency or a range of frequencies that is outside the frequency band of the NFC-EM field, thereby substantially reducing the frequency response of the resonant structure of WPT module 101 to the NFC-EM field.

It is to be appreciated that such inter-module control configuration between WPT module 101 and NFC module 102 can improve operational efficiency of communication device 100. Often times, this inter-module control configuration between WPT module 101 and NFC module 102 is needed since the WPT module 101 is often tuned close to the frequency band of the NFC-EM field and/or harmonics of thereof and the NFC module 102 is often tuned close to the frequency band of the WPT-EM field and/or harmonics thereof. Without such inter-module control configuration, the close proximity between NFW modules like WPT module 101 and NFC module 102 may lead to undesirable parasitic inductive coupling and degradation in operational efficiency of these modules. For example, WPT between WPT module 101 and the wireless power transmitter, as described above, can be degraded due to inductive coupling of NFC module 102 with the WPT-EM field. Such inductive coupling of NFC module 102 can lead to undesirable power transfer to NFC module 102 and as a result degrade WPT and wireless charging efficiency of communication device 100 as well as potentially cause permanent damage to the NFC module 102. Similarly, power harvesting of NFC module 102, as described above, can be degraded by parasitic inductive coupling of WPT module 101 with the NFC-EM field. Also, absence of the control configuration, as described above, can degrade sensitivity of NFC module 102, for example, when in reader mode of operation, due to parasitic inductive coupling of WPT module 101 with the NFC-EM field, and consequently, negatively affect maximum operable separation distance between NFC module 102 and another NFC capable device.

Referring again to FIG. 1, communication device 100 can additionally include a Bluetooth Module 104, a Global Position Module (GPS) module 106, a cellular module 108, a secure element 110, a wireless local area network (WLAN) module 112, a host processor 114, or any combination thereof which are communicatively coupled to one another via a communication interface (CI) 116. It should be noted that communication device 100 need not include all of: WPT module 101, NFC module 102, Bluetooth Module 104, GPS module 106, cellular module 108, secure element 110, WLAN module 112, and/or host processor 114. Those skilled it the relevant art(s) will recognize that other configurations and arrangements of communication device 100 are possible without departing from the spirit and scope of the present disclosure. Additionally, those skilled in the relevant art(s) will also recognize that WPT module 101, NFC module 102, Bluetooth Module 104, GPS module 106, cellular module 108, secure element 110, WLAN module 112, and/or host processor 114 need not be communicatively coupled to one another via CI 116. In these situations, those modules that are communicatively coupled to CI 116 can independently communicate with other communication devices without internal communication.

Bluetooth Module 104 can provide wireless communication between communication device 100 and another Bluetooth capable device in accordance with various Bluetooth or Bluetooth Low Energy (BLE) standards. Bluetooth Module 104 can be configurable to operate in a master mode of operation to initiate communications with another Bluetooth capable device or in a slave mode of operation to receive communications from another Bluetooth capable device.

GPS Module 106 can receive various signals from various satellites to calculate a position of communication device 100. GPS Module 106 can have a Global Navigation Satellite System (GNSS) receiver that uses the GPS, GLONASS, Galileo and/or Beidou satellite systems for calculating the position of communication device 100.

Cellular module 108 can provide wireless communication between the communication device 100 and another cellular capable device over a cellular network in accordance with various cellular communication standards such as a Third Generation Partnership Project (3GPP) Long Term Evolution (LTE) communications standard, a fourth generation (4G) mobile communications standard, or a third generation (3G) mobile communications standard to provide some examples. Cellular module 108 can communicate with one or more transceivers, referred to as base stations or access points, within the cellular network to provide voice or data communications between communication device 100 and another cellular capable device. The transceivers are often connected to a cellular telephone exchange that connects to a public telephone network or to another cellular telephone exchange within the cellular network.

Secure element 110 can securely store applications and/or information such as payment information, authentication information, ticketing information, and/or marketing information to provide some examples, within communication device 100 and can provide an environment for secure execution of these applications. Secure element 110 can be implemented as a separate secure smart card chip, in a subscriber identity module (SIM)/Universal Integrated Circuit Card (UICC), or in a secure digital (SD) card that can be inserted in communication device 100.

WLAN module 112 can provide wireless communication between communication device 100 and another WLAN capable device over a wired and/or wireless communication network in accordance with various networking protocols such a Worldwide Interoperability for Microwave Access (WiMAX) communications standard or a Wi-Fi communications standard to provide some examples. WLAN module 112 can operate as an access point to provide communications between other WLAN capable devices and a communication network or as a client to communicate with another access point, such as a wireless router to provide an example, to access a communication network.

Host processor 114 includes suitable logic, circuitry, and/or code that is configured to control overall operation and/or configuration of communication device 100. Host processor 114 can receive information from a user interface such as a touch-screen display, an alphanumeric keypad, a microphone, a mouse, a speaker, and/or from other electrical devices or host devices that are coupled to communication device 100. Host processor 114 can provide this information to WPT module 101, NFC module 102, Bluetooth Module 104, GPS module 106, cellular module 108, secure element 110, the WLAN module 112 and/or any other modules or module of communication device 100. Additionally, host processor 114 can receive information from WPT module 101, NFC module 102, Bluetooth Module 104, GPS module 106, cellular module 108, secure element 110, the WLAN module 112 and/or any other modules or module of communication device 100. This received information can be provided by host processor 114 to a user interface, to other electrical devices or host devices, and/or to WPT module 101, NFC module 102, Bluetooth Module 104, GPS module 106, cellular module 108, secure element 110, the WLAN module 112 and/or any other modules or module of communication device 100. Further, host processor 114 can execute one or more applications such as Short Message Service (SMS) for text messaging, electronic mailing, and/or audio and/or video recording to provide some examples, and/or software applications such as a calendar and/or a phone book to provide some examples.

CI 116 can route various communications between WPT module 101, NFC module 102, Bluetooth Module 104, GPS module 106, cellular module 108, secure element 110, WLAN module 112, and/or host processor 114. These communications can include various digital signals, such as one or more commands and/or data to provide some examples, various analog signals, such as direct current (DC) currents and/or voltages to provide some examples, or any combination thereof. CI 116, as well as other CIs that are discussed below, can be implemented as a series of wired and/or wireless interconnections between WPT module 101, NFC module 102, Bluetooth Module 104, GPS module 106, cellular module 108, secure element 110, host processor 114, and/or WLAN module 112. The interconnections of CI 116, as well as interconnections of other CIs that are discussed below, can be arranged to form a parallel interface to carry communications between various modules of communication device 100 in parallel using multiple conductors, a serial interface to carry communications between various modules of device 100 using a single conductor, or any combination thereof.

### AN EXEMPLARY WPT MODULE THAT CAN BE IMPLEMENTED AS PART OF THE EXEMPLARY COMMUNICATION DEVICE

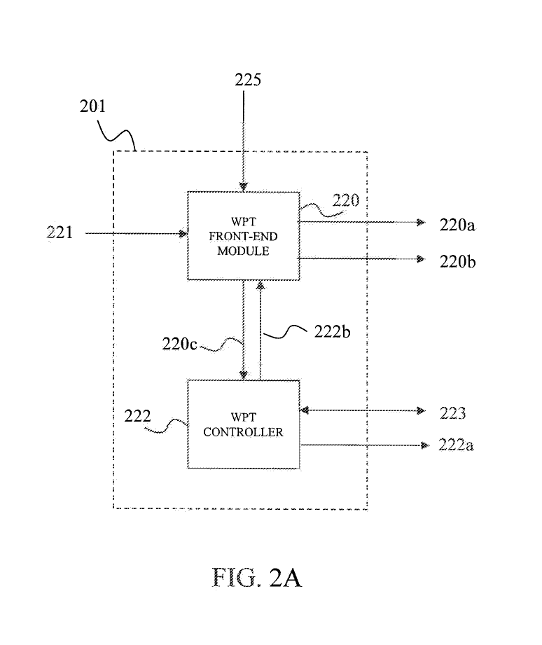

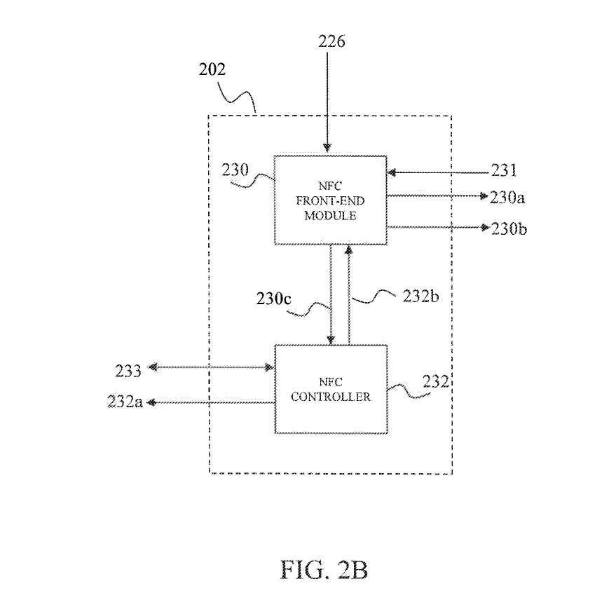

FIG. 2A illustrates a block diagram of an exemplary WPT module that can be implemented as part of the communication device according to an exemplary embodiment of the present disclosure. WPT module 201 can provide WPT from the wireless power transmitter in a substantially similar manner as WPT module 101. According to an example of this embodiment, WPT module 201 includes a WPT front end module (FEM) 220 and a WPT controller 222.

According to an embodiment, WPT system 201 can be implemented on a first substrate (or die). The first substrate can include at least WPT FEM 220 and WPT controller 222. It should be noted that the first substrate can include one or more substrates (or dies). As such, WPT FEM 220 and WPT controller 222 can be on located on different substrate on the first substrate in an example of this embodiment.

WPT FEM 220 can provide an interface between WPT module 201 and a wireless power transmitter. WPT FEM 220 can receive a WPT signal 221 from the wireless power transmitter. WPT FEM 220 can derive or harvest power from WPT signal 221 to provide a harvested power 220a for use by WPT module 201 and/or for routing to other modules within a communication device, such as the communication device 100 to provide an example. In an embodiment, WPT FEM 220 can include a rectifier for rectifying WPT signal 221 from being an alternating current (AC) signal to be a substantially direct current (DC) signal. This embodiment can also include a regulator for regulating the substantially DC current signal to provide a regulated current and/or voltage.

Additionally, WPT FEM 220 can be configured to control coupling of one or more other modules within the communication device, such as an NFC module to provide an example, for reasons similar to that described above with reference to WPT module 101. In some situations, WPT FEM 220 can detect the presence of an WPT-EM field, such as WPT signal 221, and, upon its detection, WPT FEM 220 can provide one or more control signals 220b to prevent the one or more other modules within the communication device from responding to the WPT-EM field according to an example of this embodiment. Yet further, WPT FEM 220 can communicate one or more information signals 220c to WPT controller 222 of the detected presence of the WPT-EM field. In some situations, the one or more control signals 220b and/or the one or more information signals 220c can include one or more characteristics of WPT signal 221.

Further, WPT FEM 220 can receive a control signal 225 from the one or more other modules within the communication device, such as an NFC module to provide an example. Control signal 225 prevents WPT FEM 220 from responding to another EM field, such as the NFC-EM field to provide an example, according to an example of this embodiment.

WPT controller 222 can be configured to control overall operation and/or configuration of WPT module 201. WPT controller 222 can receive the one or more information signals 220c and/or the harvested power 220a. Based on the one or more information signals 220c, WPT controller 222 can provide one or more control signals 222a to prevent the one or more other modules within the communication device from responding to the detected WPT-EM field, according to an example of this embodiment. Additionally, WPT controller 222 can communicate with one or more other modules within the communication device as an information signal 223. The information signal 223 can include data, such as the one or more information signals 220c and/or one or more commands to be executed by one or more other modules within the communication device. Further, WPT controller 222 can receive the information signal 223 from one or more other modules within the communication device. In this situation, WPT controller 222 can execute the one or more commands within the information signal 223 to control overall operation and/or configuration of WPT module 201. Yet further, WPT controller 222 can provide the one or more control signals 222b to control overall operation and/or configuration of WPT FEM 220.

### AN EXEMPLARY NFC MODULE THAT CAN BE IMPLEMENTED AS PART OF THE EXEMPLARY COMMUNICATION DEVICE

FIG. 2B illustrates a block diagram of an exemplary NFC module that can be implemented as part of the communication device according to an exemplary embodiment of the present disclosure. NFC module 202 can provide wireless communication between a communication device, such as the communication device 100 to provide an example, and another NFC capable device in accordance with various NFC standards in the reader or in the tag mode of operations in a substantially similar manner as NFC module 102. According to an example of this embodiment, NFC module 202 includes an NEC FEM 230 and an NFC controller 232.

According to an embodiment, NFC system 202 can be implemented on a second substrate (or die). The second substrate can include at least NFC FEM 230 and NEC controller 232. It should be noted that the second substrate can include one or more substrates (or dies). As such, NFC FEM 230 and NFC controller 232 can be on located on different substrate on the second substrate in an example of this embodiment.

NFC FEM 230 can provide an interface between NFC module 202 and the other NFC capable device. In a reader mode of operation, NFC FEM 230 can generate a radio frequency carrier, modulate the radio frequency carrier with information, such as data and/or one or more commands, and use the modulated carrier frequency to generate the NFC-EM field to provide a transmitted NFC communication signal 230a to the other NFC capable device. Often times, the NFC FEM 230 continues to provide the radio frequency carrier unmodulated as the transmitted NFC communication signal 230a to the other NFC capable device after information has been transferred to the other NFC capable device. This allows the other NFC capable device to modulate, typically by load modulating, the transmitted NFC communication signal 230a with information, often called a response, to form a received NFC communication signal 231 for NFC FEM 230. Alternatively, when NFC module 202 is operating in a tag mode of operation, NFC FEM 230 inductively receives a radio frequency carrier from the other NFC capable device as the received NFC communication signal 231. In this situation, NFC FEM 230 modulates, typically through load modulation, the received NFC communication signal 231 with information to provide the transmitted NFC communication signal 230a to the other NFC capable device. Additionally or optionally, NFC FEM 230 can derive or harvest power from the received NFC communication signal 231 to provide a harvested NFC power for use by NFC module 202. In an embodiment, NFC FEM 230 can include a rectifier for rectifying the received NFC communication signal 231 from being an alternating current (AC) signal to be a substantially direct current (DC) signal. This embodiment can also include a regulator for regulating the substantially DC current signal to provide a regulated current and/or voltage.

Additionally, NFC FEM 230 can be configured to control coupling of one or more other modules within the communication device, such as a WPT module to provide an example, for reasons similar to that described above with reference to NFC module 102. In some situations, NFC FEM 230 can detect the presence of an NFC-EM field, such as the received NFC communication signal 231, and, upon its detection, NFC FEM 230 can provide one or more control signals 230b to prevent the one or more other modules within the communication device from responding to the NFC-EM field according to an example of this embodiment. Yet further, NFC FEM 230 can communicate one or more information signals 230c to NFC controller 232 of the detected presence of the NFC-EM field. In some situations, the one or more control signals 230b and/or the one or more information signals 230c can include one or more characteristics of the received NFC communication signal 231.

Further, NFC FEM 230 can receive a control signal 226, such as control signal 222a to provide an example, from the one or more other modules within the communication device. Control signal 226 prevents NFC FEM 230 from responding to another EM field, such as the WPT-EM field to provide an example, according to an example of this embodiment.

NFC controller 232 can be configured to control overall operation and/or configuration of NFC module 202. NFC controller 232 can receive the one or more information signals 230c. Based on the one or more information signals 230c, NFC controller 232 can provide one or more control signals 232a, such as control signal 225 to provide an example, to prevent the one or more other modules within the communication device from responding to the detected NFC-EM field, according to an example of this embodiment. Additionally, NFC controller 232 can route the one or more information signals 230c to one or more other modules within the communication device as an information signal 233. The information signal 233 can include data, such as the one or more information signals 230c and/or one or more commands to be executed by one or more other modules within the communication device. Further, NFC controller 232 can receive the information signal 223 from one or more other modules within the communication device. In this situation, NFC controller 232 can execute the one or more commands within the information signal 233 to control overall operation and/or configuration of the NFC module 202 and/or provide the information signal 233 as an information signal 232b having data to be transferred to the other NFC capable device and/or one or more commands to control overall operation and/or configuration of NFC FEM 230.

Further, NFC controller 232 can perform other functionality as described in International Standard ISO/IE 18092:2004(E), “Information Technology—Telecommunications and Information Exchange Between Systems—Near Field Communication—Interface and Protocol (NFCIP-1),” published on Apr. 1, 2004 and International Standard ISO/IE 21481:2005(E), “Information Technology—Telecommunications and Information Exchange Between Systems—Near Field Communication—Interface and Protocol-2 (NFCIP-2),” published on Jan. 15, 2005, each of which is incorporated by reference herein in its entirety.

### AN EXEMPLARY WPT FRONT-END MODULE THAT CAN BE IMPLEMENTED AS PART OF THE EXEMPLARY WPT MODULE

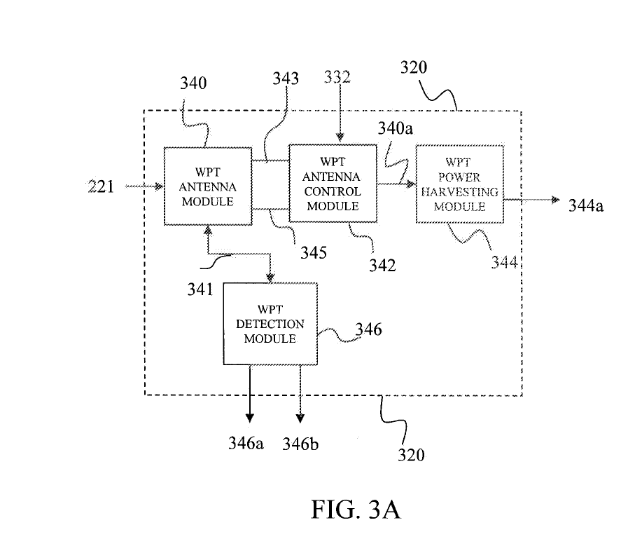

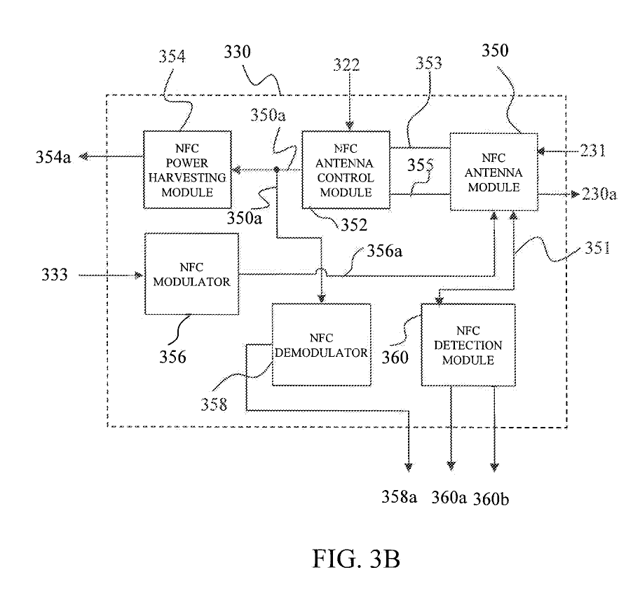

FIG. 3A illustrates a block diagram of a WPT FEM that can be implemented as part of the exemplary WPT module according to an embodiment of the present disclosure. A WPT FEM 320 provides an interface between a WPT module, such as the WPT module 101 and/or WPT module 201 to provide some examples, and a wireless power transmitter. The WPT FEM 320 can inductively receive various signals from the wireless power transmitter and recover various power signals from these various signals. The WPT FEM 320 can represent an exemplary embodiment of the WPT FEM 220.

According to an example of this embodiment, WPT FEM 320 includes a WPT antenna module 340, a WPT antenna control module 342, a WPT power harvesting module 344, and a WPT detection module 346. In another example of this embodiment, WPT antenna control module 342 can be an external part of WPT FEM 320 and coupled to WPT antenna module 340. In this situation, the external WPT antenna control module and WPT FEM 320 can be located on different substrates (or dies).

WPT antenna module 340 can inductively receive WPT signal 221 from the wireless power transmitter to provide a WPT recovered signal 340a. According to an embodiment, WPT antenna module 340 can include an inductive coupling element, such as a resonant tuned circuit (not shown), to provide an example, that can be tuned to a frequency (e.g., carrier frequency) of the WPT-EM field generated by the wireless power transmitter to provide the received WPT signal 221. The resonant tuned circuit can be characterized by an impedance that can be tuned to resonate at a specific frequency, or range of frequencies, referred to as its resonant frequency. For example, the resonant tuned circuit of WPT antenna module 340 can include a series resonant LC circuit. As another example, the resonant tuned circuit may include a parallel resonant LC circuit. In an embodiment, the resonant tuned circuit of WPT antenna module 340 can be tuned to resonate at a resonant frequency of approximately 6.78 MHz.

WPT antenna control module 342 can control the inductive coupling of the received WPT signal 221 onto WPT antenna module 340 based on one or more control signals 332, such as control signals 225 and 232a to provide some examples. WPT antenna control module 342 can be activated and/or deactivated by the one or more control signals 332 to control WPT antenna module 340 from parasitic inductive coupling with another EM field, such as the NFC-EM field to provide an example.

Even though the frequency associated with this other EM field may not be the resonant frequency of WPT antenna module 340, this other EM field can weakly couple onto WPT antenna module 340 due to close proximity between WPT module 301 and other modules within a communication device, such as the communication device 100 to provide an example. WPT antenna control module 342 can be configured to detune the resonant tuned circuit of WPT antenna module 340 to shift its resonant frequency outside the frequency band of this other EM field or harmonics of the frequency band of this other EM field.

WPT antenna control module 342 can include a detuning circuit coupled to the resonant tuned circuit of WPT antenna module 340, in an example of this embodiment. The detuning circuit can include a voltage controlled impedance such as, but not limited to, a variable capacitor and a transistor that can be coupled across terminals 343 and 345 of the resonant tuned circuit of WPT antenna module 340 in accordance to an embodiment. According to various examples of this embodiment, detuning circuit transistor can be implemented using a metal oxide semiconductor field-effect transistor (MOSFET), a bipolar junction transistor (BJT), a junction field effect transistor (JFET), or any FETs suitable for operating as a voltage controlled impedance. The transistor can represent a voltage controlled impedance that is configured to operate in a non-conducting mode of operation or a conducting mode of operation, such as a linear mode of operation or a saturation mode of operation to provide some examples. Alternatively, the transistor may represent switching transistors that are configured to be activated and deactivated.

The detuning circuit of WPT antenna control module 342, when activated by applying the one or more control signals 332 to WPT antenna control module 342, can adjust an impedance of the resonant timed circuit to adjust or detune the resonant frequency of the resonant tuned circuit from its optimal resonant frequency. Alternatively, removing the one or more control signals 332 can deactivate WPT antenna control module 342, and thus, electrically decouple the detuning circuit from WPT antenna module 340 and re-tune WPT antenna module 340 to its optimal resonant frequency.

WPT power harvesting module 344 can derive or harvest power from WPT recovered signal 340a to provide a WPT harvested power 344a. In an example embodiment, the WPT power harvesting module 344 includes a rectifier to rectify WPT recovered signal 343 to provide a rectified WPT power. In this example embodiment, WPT power harvesting module 344 additionally includes a regulator to regulate rectified WPT power to provide WPT harvested power 344a. In some situations, WPT harvested power 344a can be provided to other modules of the communication device.

WPT detection module 346 may be communicatively coupled to WPT antenna module 340 via a CI 341. WPT detection module 346 can be configured to detect the presence of WPT signal 221 within the WPT-EM field. Specifically, WPT detection module 346 can detect one or more characteristics of WPT signal 221, such as a frequency of WPT signal 221, an intensity of WPT signal 221, and/or voltage or current induced by WPT signal 221 to provide some examples.. Additionally, WPT detection module 346 can be configured to communicate information 346a, such as information signal 220c to provide an example, when the one or more characteristics of WPT signal 221 are determined to be substantially greater than or equal to one or more detection thresholds. In an example of this embodiment, most of the energy of WPT signal 221 is concentrated around 6.78 MHz, and upon detection of this energy around approximately 6.78 MHz, WPT detection module 346 can communicate information 346a of the presence of the WPT-EM field to a WPT controller, such as WPT controller 222 to provide an example. Alternatively, or in addition to, WPT detection module 346 can communicate information 346a of the presence of the WPT-EM field to host processor of the communication device. In another alternative, or in addition to, WPT detection module 346 can be configured to generate one or more control signals 346b, such as control signal 220b to provide an example, to activate an NFC antenna control module. The one or more control signals 346b can include a voltage signal.

In another example of this embodiment, most of the energy of WPT signal 221 is concentrated around 6.78 MHz and most of the energy of NFC signal 231 is concentrated around 13.56 MHz. When energy around approximately 6.78 MHz and around 13.56 MHz is detected in this example, WPT detection module 346 can be configured to communicate information 346a of the presence of the WPT-EM field and the NFC-EM field to the WPT controller to deactivate the NFC antenna control module.

### AN EXEMPLARY NFC FRONT-END MODULE THAT CAN BE IMPLEMENTED AS PART OF THE EXEMPLARY NFC MODULE

FIG. 3B illustrates a block diagram of an NFC FEM that can be implemented as part of the exemplary NFC module according to an embodiment of the present disclosure. An NFC FEM 330 provides an interface between an NFC module, such as the NFC module 102 and/or NFC module 202 to provide some examples, and another NFC capable device. The NFC FEM 330 can inductively transmit various NFC communication signals to the other NFC capable device and inductively receive various NFC communication signals from the other NFC capable device. Additionally or optionally, NFC FEM 330 can recover various power signals from these various NFC communication signals. The NFC FEM 330 can represent an exemplary embodiment of the NFC FEM 230.

According to an example of this embodiment, NFC FEM 330 includes an NFC antenna module 350, an NFC antenna control module 352, an NFC power harvesting module 354, an NFC modulator 356, an NFC demodulator 358, and an NFC detection module 360. In another example of this embodiment, NFC antenna control module 352 can be an external part of NFC FEM 330 and coupled to NFC antenna module 350. In this situation, the external NFC antenna control module and NFC FEM 330 can be located on different substrates (or dies).

NFC antenna module 350 can inductively receive NFC signal 231 from another NFC capable device to provide an NFC communication recovered signal 350a. According to an embodiment, NFC antenna module 350 can include an inductive coupling element, such as a resonant tuned circuit (not shown), to provide an example, that can be tuned to a frequency (e.g., carrier frequency) of the NFC-EM field generated by the other NFC capable device to provide the received NFC signal 231. The resonant tuned circuit can be characterized by an impedance that can be tuned to resonate at a specific frequency, or range of frequencies, referred to as its resonant frequency. The resonant tuned circuit of NFC antenna module 350 can include a series resonant LC circuit or a parallel resonant LC tuned circuit according to examples of this embodiment. In an embodiment, the resonant tuned circuit of NFC antenna module 350 can be tuned to resonate at a resonant frequency of approximately 13.56 MHz.

Additionally, NFC antenna module 350 can provide NFC transmitted communication signal 230a based on a modulated information signal 356a from NFC modulator 356. When NFC module 302 is operating in the reader mode of operation, NFC antenna module 350 can apply modulated information signal 356a to the inductive coupling element of NFC antenna module 350 to generate an NFC-EM field to provide NFC transmitted communication signal 230a to the other NFC capable device.

NFC antenna control module 352 can control the inductive coupling of the received NFC communication signal 230a onto NFC antenna module 350 based on one or more control signals 332, such as control signals 226 and 222a to provide some examples. NFC antenna control module 352 can be activated and/or deactivated by the one or more control signals 322 to control NFC antenna module 350 from parasitic inductive coupling with another EM field, such as the WPT-EM field to provide an example.

Even though the frequency associated with this other EM field may not be the resonant frequency of NFC antenna module 350, this other EM field can weakly couple on NFC antenna module 350 due to close proximity between WPT module 301 and NFC module 302 in a communication device, such as the communication device 100 to provide an example. NFC antenna control module 352 can be configured to detune the resonant tuned circuit of NFC antenna module 350 to shift its resonant frequency outside the frequency band of this other EM field or harmonics of the frequency band of this other EM field.

NFC antenna control module 352 can include a detuning circuit coupled to the resonant tuned circuit of NFC antenna module 350, in an example of this embodiment. The detuning circuit can include a voltage controlled impedance such as, but not limited to, a variable capacitor and a transistor that can be coupled across terminals 353 and 355 of the resonant tuned circuit of NFC antenna module 350 in accordance to an embodiment. According to various examples of this embodiment, detuning circuit transistor can be implemented using a metal oxide semiconductor field-effect transistor (MOSFET), a bipolar junction transistor (BJT), a junction field effect transistor (JFET), or any FETs suitable for operating as a voltage controlled impedance. The transistor can represent a voltage controlled impedance that is configured to operate in a non-conducting mode of operation or a conducting mode of operation, such as a linear mode of operation or a saturation mode of operation to provide some examples. Alternatively, the transistor may represent switching transistors that are configured to be activated and deactivated.

The detuning circuit of NFC antenna control module 352, when activated by applying the one or more control signals 322 to NFC antenna control module 352, can adjust an impedance of the resonant tuned circuit to adjust or detune the resonant frequency of the resonant tuned circuit from its optimal resonant frequency. Alternatively, removing the one or more control signals 322 can deactivate NFC antenna control module 352, and thus, electrically decouple the detuning circuit from NFC antenna module 350 and re-tune NFC antenna module 350 to its optimal resonant frequency.

NFC power harvesting module 354 can derive or harvest power from NFC communication recovered signal 350a to provide a NFC harvested power 354a. In an example embodiment, NFC power harvesting module 354 includes a rectifier to rectify NFC communication recovered signal 350a to provide a rectified NFC power. In this example embodiment, NFC power harvesting module 354 additionally includes a regulator to regulate the rectified NFC power to provide NFC harvested power 354a. In some situations, NFC harvested power 354a can be provided to other modules of the communication device.

NFC modulator 356 can be configured to modulate transmission information 333, such as information signal 232b to provide an example, onto a carrier wave, such as a radio frequency carrier wave having a frequency of approximately 13.56 MHz to provide an example, when an NFC module, such as NFC module 102 and/or NFC module 202 to provide some examples, is operating in a reader mode of operation.. The modulation can be performed using any suitable analog or digital modulation technique to provide a modulated information signal 356a. The suitable analog or digital modulation technique may include amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s). In some situations, NFC modulator 356 can simply provide the carrier wave as modulated information signal 356a. Additionally, NFC modulator 356 can modulate transmission information 333 using the suitable analog or digital modulation technique to provide modulated information signal 356a when the NFC module is operating in the tag mode of operation.

NFC demodulator 358 can be configured to demodulate the recovered NFC communication signal 350a using any suitable analog or digital demodulation technique to provide a recovered information signal 358a. The suitable analog or digital modulation technique may include amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s). The recovered information signal 358a can be provided to an NFC controller, such as NFC controller 232 to provide an example, or other modules of the communication device.

NFC detection module 360 may be communicatively coupled to NFC antenna module 350 via a CI 351. NFC detection module 360 can be configured to detect the presence of NFC signal 231 within the NFC-EM field. Specifically, NFC detection module 360 can detect one or more characteristics of NFC signal 231, such as a frequency of NFC signal 231, an intensity of NFC signal 231, and/or voltage or current induced by NFC signal 231 to provide some examples. Additionally, NFC detection module 360 can be configured to communicate information 360a, such as information signal 230c to provide an example, when one or more characteristics of NFC signal 231 are determined to be substantially greater than or equal to one or more detection thresholds. In an example of this embodiment, most of the energy of the NFC signal 231 is concentrated around 13.56 MHz, and upon detection of this energy around approximately 13.56 MHz, NFC detection module 360 can communicate information 360a of the presence of the NFC-EM field to a NFC controller, such as NFC controller 232 to provide an example. Alternatively, or in addition to, NFC detection module 360 can communicate information 360a of the presence of the NFC-EM field to host processor of the communication device. In another alternative, or in addition to, NFC detection module 360 can be configured to generate one or more control signals 360b, such as control signal 230b to provide an example, to activate an NFC antenna control module. The one or more control signals 360b can include a voltage signal.

In another example of this embodiment, most of the energy of NFC signal 231 is concentrated around 13.56 MHz and most of the energy of WPT signal 221 is concentrated around 6.78 MHz. When energy around approximately 13.56 MHz and around 6.78 MHz is detected in this example, NFC detection module 360 can be configured to communicate information 360a of the presence of the NFC-EM field and the WPT-EM field to the NFC controller to deactivate the WPT antenna control module.

### AN EXEMPLARY WPT CONTROLLER THAT CAN BE IMPLEMENTED AS PART OF THE EXEMPLARY WPT MODULE

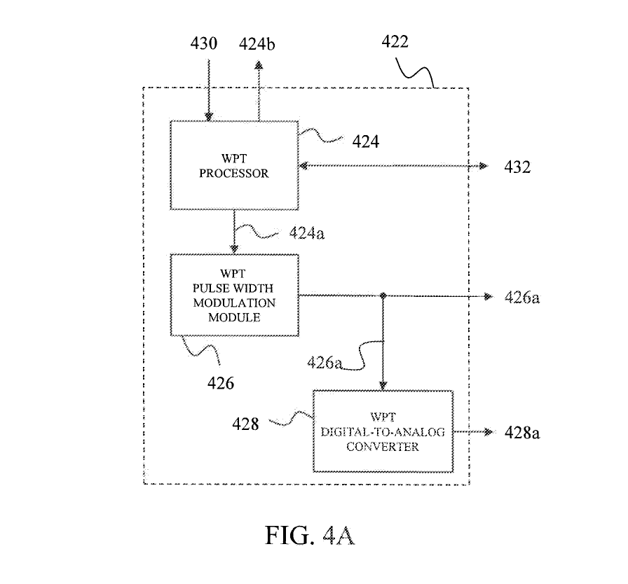

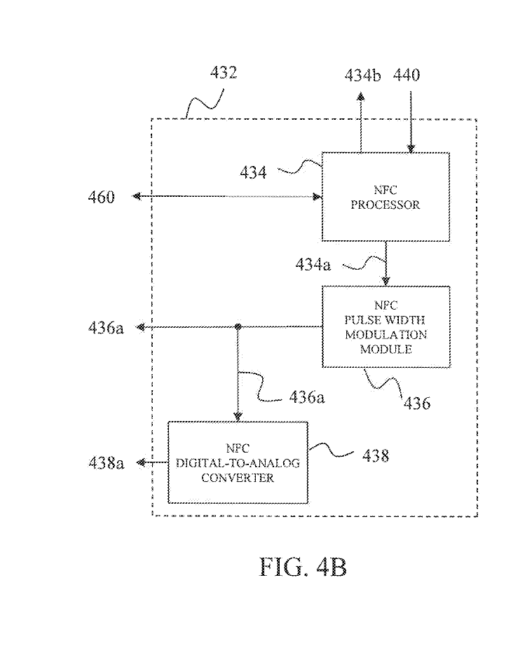

FIG. 4A illustrates a block diagram of a WPT controller that can be implemented as part of the exemplary WPT module according to an embodiment of the present disclosure. A WPT controller 422 controls overall operation and/or configuration of a WPT module, such as the WPT module 101 and/or WPT module 201 to provide some examples. The WPT controller 422 can represent an exemplary embodiment of the WPT controller 222.

According to an example of this embodiment, WPT controller 422 includes a WPT processor 424, a WPT pulse width modulation (PWM) module 426, and a WPT digital-to-analog converter (DAC) 428. In another example of this embodiment, WPT DAC 428 can be an external part of WPT controller 422 and coupled to WPT PWM 426.

WPT processor 424 receives one or more signals 430, such as information signals 220c to provide an example, from modules within the communication device, Based on the one or more signals 430, WPT processor 424 can generate one or more control information signals 424a for controlling one or more other modules within the communication device. Additionally, WPT processor 424 can communicate with one or more other modules within the communication device as an information signal 450, such as information signal 223 to provide an example. Further, WPT controller 424 can receive data and/or one or more commands as information signal 450 from one or more other modules within the communication device for controlling overall operation and/or configuration of the WPT module. Yet further, WPT processor 424 can provide one or more control signals 424b to control overall operation and/or configuration of one or more modules within the communication device,. Additionally or optionally, WPT processor 424 can receive harvested power, such as harvested power 220a to provide an example, from a WPT signal received from a wireless power transmitter.

WPT PWM module 426 pulse width modulates the one or more control information signals 424a, to produce modulated control signals 426a, such as control signals 222a and/or control signals 322 to provide some examples. In an example of this embodiment, PWM module 426 can provide the one or more modulated control signals 426a at a first logic level (e.g., logic one) for activating one or more control modules, such as NFC antenna control module 352 to provide an example, within the communication device when a WIT signal (e.g., WPT signal 221) is detected. Additionally, in this example, PWM module 426 can provide the one or more modulated control signals 426a at a second logic level (e.g., logic zero) for deactivating the one or more control modules within the communication device when a WPT signal and an NFC signal is detected.

In some situations, the one or control modules within the communication device may require analog control signals corresponding to the one or more modulated control signals 426a for activation and/or deactivation. In these situations, WPT DAC 428 converts one or more modulated control signals 426a to provide one or more analog control signals 428a to the one or more control modules within the communication device.

### AN EXEMPLARY NFC CONTROLLER THAT CAN BE IMPLEMENTED AS PART OF THE EXEMPLARY NFC MODULE

FIG. 4B illustrates a block diagram of a NFC controller that can be implemented as part of the exemplary NFC module according to an embodiment of the present disclosure. An NFC controller 432 controls overall operation and/or configuration of an NFC module, such as the NFC module 102 and/or NFC module 202 to provide some examples. The NFC controller 432 can represent an exemplary embodiment of the NFC controller 232.

According to an example of this embodiment, NFC controller 432 includes an NFC processor 434, an NFC pulse width modulation (PWM) module 436, and an NFC digital-to-analog converter (DAC) 438 located on a single substrate (or die). In another example of this embodiment, NFC DAC 438 can be an external part of NFC controller 432 and coupled to NFC PWM 436.

NFC processor 434 receives one or more signals 440, such as information signals 230c to provide an example, from modules within the communication device. Based on the one or more signals 440, NFC processor 434 can generate one or more control information signals 434a for controlling one or more other modules within the communication device. Additionally, NFC processor 434 can communicate with one or more other modules within the communication device as an information signal 460, such as information signal 233 to provide an example. Further, NFC controller 434 can receive data and/or one or more commands as information signal 460 from one or more other modules within the communication device for controlling overall operation and/or configuration of the NFC module and/or for transferring to another NFC capable device. Yet further, NFC processor 424 can provide one or more control signals 434b to control overall operation and/or configuration of one or more modules within the communication device. Additionally or optionally, NFC processor 434 can receive power harvested from an NFC signal received from the other NFC capable device.

NFC PWM module 436 pulse width modulates the one or more control information signals 434a, to produce modulated control signals 436a, such as control signals 232a and/or control signals 332 to provide some examples. In an example of this embodiment, PWM module 436 can provide the one or more modulated control signals 436a at a first logic level (e.g., logic one) for activating one or more control modules, such as WPT antenna control module 342 to provide an example, within the communication device when an NFC signal (e.g., NFC signal 231) is detected. Additionally, in this example, PWM module 436 can provide the one or more modulated control signals 436a at a second logic level (e.g., logic zero) for deactivating the one or more control modules within the communication device when a WPT signal and an NFC signal is detected.

In some situations, one or control modules within the communication device may require analog control signals corresponding to the one or more modulated control signals 436a for activation and/or deactivation. In these situations, NFC DAC 438 converts one or more modulated control signals 436a to provide one or more analog control signals 438a to the one or more control modules within the communication device.

### A FLOWCHART OF EXEMPLARY OPERATIONAL STEPS OF AN NFW MODULE OF THE EXEMPLARY COMMUNICATION DEVICE

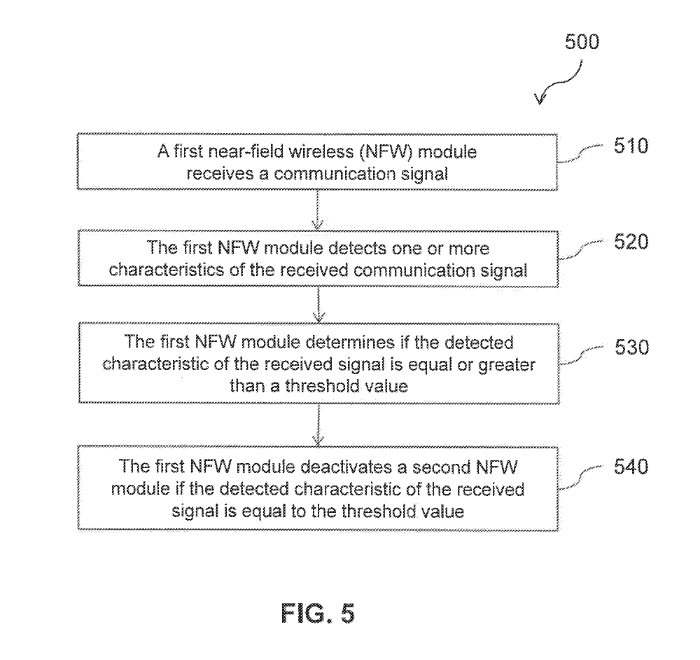

FIG. 5 is a flowchart illustrating exemplary operational steps of a first NFW module for controlling a second NFW module based on a communication signal received by the first NFW module. WPT module 101 and/or WPT module 201 can represent the first NFW module, and NFC module 102 and/or NFC module 202 can represent the second NFW module in an example of this embodiment. In another example, NFC module 102 and/or NFC module 202 can represent the first NFW module, and WPT module 101 and/or WPT module 201 can represent the second NFW module. It should be noted that the present disclosure is not limited to this operational description. The following discussion describes the steps in FIG. 5.

At step 510, the first NFW module receives a communication signal, such as communication signals 221, 231 to provide some examples.

At step 520, the first NFW module detects one or more characteristics of the received communication signal. For example, the first NFW detects a frequency of the received communication signal, an intensity of the received communication signal, and/or voltage or current induced by the received communication signal.

At step 530, the first NFW module determines whether the detected one or more characteristics of the received communication signal are substantially equal or greater than one or more thresholds of a first detection module. For example, the threshold value is an operating frequency of the first NFW module.

At step 540, the first NFW module deactivates a second NFW module or one or more modules within the second NFW module when the detected characteristic of the received communication signal is substantially equal or greater than a threshold value of the first detection module. For example, in an example of this embodiment, the first NFW module detunes an antenna module of the second NFW module to prevent from responding to the received communication signal.

### CONCLUSIONS

It is to be appreciated that the Detailed Description section, and not the Abstract section, is intended to be used to interpret the claims. The Abstract section can set forth one or more, but not all exemplary embodiments, of the present disclosure, and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It will be apparent to those skilled in the relevant art(s) that various changes in form and detail can be made therein without departing from the spirit and scope of the present disclosure. Thus, the present disclosure should not be limited by any of the above-described exemplary embodiments, but should be defined only in accordance with the following claims and their equivalents.

What is claimed is:

1. A communication device, comprising:
a first antenna module configured to inductively couple with a first magnetic field;
a first antenna control module configured to control the first antenna module from coupling with the second magnetic field;
a second antenna module configured to inductively couple with a second magnetic field; and
a second antenna control module configured to control the second antenna module from coupling with the first magnetic field.

2. The communication device of claim 1, further comprising:
a first detection module configured to detect a characteristic of a received signal of the communication device;
a first controller configured to:
activate the second antenna control module when the detected characteristic corresponds to the first magnetic field; and
deactivate the second antenna control module when the detected characteristic corresponds to the second magnetic field..

3. The communication device of claim 2, further comprising:
a second detection module configured to detect a characteristic of a received signal of the communication device;
a second controller configured to:
activate the first antenna control module when the detected characteristic corresponds to the second magnetic field; and
deactivate the first antenna control module when the detected characteristic corresponds to the first magnetic field.

4. The communication device of claim 1, wherein the first antenna control module comprises:
a capacitive element configured to detune the first antenna module when activated to prevent coupling of the first antenna module with the second magnetic field.

5. The communication device of claim 1, wherein the second antenna control module comprises:
a capacitive element configured to detune the second antenna module when activated to prevent coupling of the second antenna module with the first magnetic field.

6. The communication device of claim 1, wherein the first antenna control module comprises:
a field-effect transistor configured to detune the first antenna module when activated to prevent coupling of the first antenna module with the second magnetic field.

7. The communication device of claim 1, wherein the second antenna control module comprises:
a field-effect transistor configured to detune the second antenna module when activated to prevent coupling of the second antenna module with the first magnetic field.

8. The communication device of claim 1, further comprising a first detection module configured to generate a control signal to activate the second antenna control module for controlling the second antenna module.

9. The communication device of claim 1, further comprising a second detection module configured to generate a control signal to activate the first antenna control module for controlling the second first module.

10. The communication device of claim 1, further comprising a first detection module configured to generate a voltage signal to activate the second antenna control module for controlling the second antenna module.

11. The communication device of claim 1, further comprising a second detection module is further configured to generate a voltage signal to activate the first antenna control module for controlling the second first module.

12. The communication device of claim 1, further comprising:
a first detection module configured to detect an induced voltage at the first antenna module; and
a first controller configured to activate the second antenna control module when the detected induced voltage is equal or greater than a first threshold voltage.

13. The communication device of claim 13, further comprising:
a second detection module configured to detect an induced voltage at the second antenna module; and
a second controller configured to activate the first antenna control module when the detected induced voltage is equal or greater than a second threshold voltage.

14. The communication device of claim of claim 1, wherein the first antenna module and the first antenna control module are located on a first substrate; and
wherein the second antenna module and the second antenna control module are located on a second substrate.

15. The communication device of claim of claim 1, wherein the first antenna module and the first antenna control module is located on a first substrate and a second substrate, respectively; and
wherein the second antenna module and the second antenna control module is located on a third substrate and a fourth substrate, respectively.

16. The communication device of claim of claim 1, wherein the first antenna module and the first antenna control module are configured as parts of a wireless power transfer module, and
wherein the second antenna module and the second antenna control module are configured as parts of a near-field communication module.

17. In a communication device, a method comprising:
detecting a characteristic of a received signal of the communication device;
determining whether the detected characteristic corresponds to a first magnetic field or a second magnetic field;
controlling a first or second antenna module when the detected characteristic is determined to correspond to the second or first magnetic field, respectively.

18. The method of claim 17, wherein the controlling comprises:
detuning the first antenna module when the detected characteristic is determined to correspond to the second magnetic field; or
detuning the second antenna module when the detected characteristic is determined to correspond to the first magnetic field is detected.

19. The method of claim 17, further comprising:
detecting an induced voltage at the first and second antenna module;
determining whether the detected induced is equal or greater than a first or second threshold voltage; and
controlling the first or second antenna module when the detected induced voltage is determined to be equal or greater than the second or first induced voltage, respectively.

20. A module, comprising:
a first near-field wireless (NFW) module having a first antenna module configured to operate with a first protocol; and
a second NFW module having a second antenna module configured to operate with a second protocol,
wherein the first NFW module is further configured to control operation of the second NFW module when a first protocol parameter is detected, and
wherein the second NFW module is further configured to control operation of the first NFW module when a second protocol parameter is detected.

21. The module of claim 20, wherein the first protocol parameter is a first carrier frequency and the second protocol parameter is a second carrier frequency.

22. The module of claim 20, wherein the first NFW module is configured to detune the second antenna module when the first protocol parameter is detected to prevent inductive coupling of the second antenna module at the first carrier frequency.

23. The module of claim 20, wherein the second NFW module is configured to detune the first antenna module when the second protocol parameter is detected to prevent inductive coupling of the first antenna module at the second carrier frequency.

24. The module of claim 20, wherein the first NFW module is further configured to detect an induced voltage and detune the second antenna module in response to the detected induced voltage being larger than a threshold voltage.

25. The module of claim of claim 20, wherein the first NFW module is a wireless power transfer module, and
wherein the second NFW module is a near-field communication module.
